(19) United States
(12) Patent Application Publication
(10) Pub. No.: US 2005/0047848 A1
(43) Pub. Date: Mar. 3, 2005

(54) Tip applicator with Venturi structure

(76) Inventor: Robert Carraher, Ridgefield, CT (US)

Correspondence Address: TARO PHARMACEUTICALS, 5 SKYLINE DRIVE, HAWTHORNE, NY, 10532, US

(21) Appl. No.: 10/897,991

(22) Filed: Jul. 22, 2004

Related U.S. Application Data
(60) Provisional application No. 60/496,644, filed on Aug. 19, 2003.

(51) Int. Cl. B43M 11/06; B05C 11/00

(52) U.S. Cl. 401/266; 401/265; 401/183

(57) ABSTRACT

A tip applicator includes a tip head having a truncated body forming an interior, an applicator end and a receiving end. Further the tip applicator includes a concave applicator surface disposed on the applicator end and having a discharge opening within. The tip head also includes a Venturi structure wherein one end of the Venturi structure opens to the discharge opening and another end opens to the receiving end of the truncated body. The Venturi structure is configured to increase the velocity of a substance being transported therein and decrease the pressure inside the Venturi structure. Thus, the Venturi structure assists in discharging the substance and in the “recapture” of the substance back into a pliable tube.

### RELATED APPLICATIONS

This application claims priority to Provisional Application Ser. No. 60/496,644, the entirety of which is incorporated herein by reference.

### BACKGROUND OF THE INVENTION

I. Field of the Invention

The present invention relates to an applicator for applying a semi-solid from a dispensing tube.

II. Discussion of the Related Art

Applicators for dispensing a viscous or semi-solid substance topically to the lips or skin are well known in the art. For example, U.S. Pat. No. 4,887,924 to Green discloses a angled tip applicator for dispensing an emollient from a tube. FIG. 1 illustrates Green's applicator which has a convex applicator wall 1. Green states that the convex shape allows for excellent spreading of the emollient on the user's lips. However, a convex shape does not allow for the user to “pool” some of the emollient in the tip if the application of a large amount of emollient is required. Additionally, while a convex shape facilitates spreading on a user's lips, the shape actually hinders the application of an emollient to other sections of the user's body, including between the fingers and toes and relatively ‘flat’ sections of skin. The convex shape of Green essentially emulates that of a fingertip.

Further, Green discloses a passage 2 extending into the tip to transport the emollient from the tube 3 to the discharge opening 4. The passage is not integrally molded to the tip and emollient can be entrained between the passage and the vertical wall (see, location 5), thus wasting emollient. Additionally, the entrained emollient can spoil or solidify and may then contaminate fresh emollient prior to discharge. Also, passage 2 has a uniform diameter throughout its length and cannot assist in increasing the velocity of the emollient at the moment of discharge.

See also U.S. Pat. No. 2,442,503 to Melnikoff which discloses a concave tip to apply cosmetics to the lips but does not integrate the concave tip with a structure to increase the velocity of the cosmetic.

Thus, there is a need in the art for a concave applicator tip and a structure to assist in the discharge of the semi-solid material. Additionally, there is a need for a discharge tube integrated with the applicator tip to prevent entrainment of the semi-solid material.

### SUMMARY OF THE INVENTION

The invention provides for a tip applicator that includes a tip head having a truncated body forming an interior, an applicator end and a receiving end. Further the tip applicator includes a concave applicator surface disposed on the applicator end and having a discharge opening within. The tip head also includes a Venturi structure wherein one end of the Venturi structure opens to the discharge opening and another end opens to the receiving end of the truncated body.

The Venturi structure preferably comprises a short tube with a constricted throat or neck. The constriction causes the velocity of a substance being transported therein to increase and to decrease the pressure inside the Venturi structure. Thus, the Venturi structure assists in discharging the substance and in the “recapture” of the substance back into a pliable tube.

Another aspect of the invention provides a tip applicator which includes a discharge tube having a discharge end receiving to the discharge opening and having a first width; an opposite end receiving to the receiving end and having a second width; and a neck portion disposed between the discharge end and the opposite end having a third width that is smaller than both the first width and the second width. Additionally, the first width can equal the second width.

Another aspect of the invention provides a discharge opening having a perimeter and a point of inflection disposed on the concave applicator surface at the discharge opening. Further, the discharge tube includes a curved wall originating at the point of inflection, spanning the entire perimeter of the discharge opening and depending into the truncated body. A neck portion depends from the curved wall and has a perimeter less than the perimeter of the discharge opening, and a bottom curved wall depends from the neck portion and has a perimeter greater than the neck portion's perimeter and opens to the receiving end of the truncated body. The curved wall and the bottom curved wall can be concave or convex.

A further aspect provides a discharge opening having a perimeter and a point of intersection disposed on the concave applicator surface at the discharge opening. A discharge tube includes a straight wall originating at point of intersection which spans the perimeter of discharge opening and the straight wall depends into the truncated body. The discharge tube further includes a neck portion depending from the straight wall and having a perimeter less than the perimeter of the discharge opening. Further, a bottom straight wall depends from the neck portion and has a perimeter greater than the neck portion perimeter and opens to the receiving end of the truncated cylinder.

### BRIEF DESCRIPTION OF THE DRAWING FIGURES

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a partial cross-sectional view of a prior art applicator tip;

FIG. 2 is an exploded view of an applicator tip and cap of the present invention;

FIG. 3 is a detail view, partially in section, of an angled concave applicator surface of the applicator tip and Venturi structure of the present invention;

FIG. 4 is a cross-sectional view of a horzontal concave applicator surface of the applicator tip and Venturi structure of the present invention;

FIG. 5 is a cross-sectional view of the applicator tip and integrated Venturi structure;

FIG. 6 is a side view, partially in section, of another embodiment of the applicator tip of the present invention;

FIG. 7 is a side view of an embodiment of a cap;

FIG. 8 is a side view, partially broken away, of another embodiment of a cap;

FIG. 9 is a partial cut-away view of the topical substance being discharged;

FIG. 10 is a partial cut-away view of the topical substance after being discharged;

FIG. 11 is a magnified cross-sectional view of the topical substance after being discharged;

FIG. 12 is a partial cut-away view of another cap embodiment;

FIG. 13 is a side view, partially cut away, of another cap embodiment;

FIG. 14 is a partial cut-away view of another cap embodiment;

FIG. 15 is a partial cut-away view of another cap embodiment with a shoulder;

FIG. 16 is a partial cut-away view of the threading;

FIG. 17 is an exploded and partial cut-away view of another embodiment of the threading;

FIG. 18 is a cross-sectional view of an applicator tip and a discharge tube of the present invention;

FIG. 19 is a cross-sectional view of another embodiment of the applicator tip and discharge tube of the present invention;

FIG. 20 is a perspective view of an embodiment of the applicator tip;

FIG. 21 is a cross-sectional view of another embodiment of the discharge tube;

FIG. 22 is a cross-sectional view of another embodiment of the discharge tube;

FIG. 23 is a magnified view of the discharge opening of FIG. 21;

FIG. 24 is a magnified view of the discharge opening of FIG. 22; and

FIG. 25 is a detail view, partially in section, of another embodiment of the discharge tube.

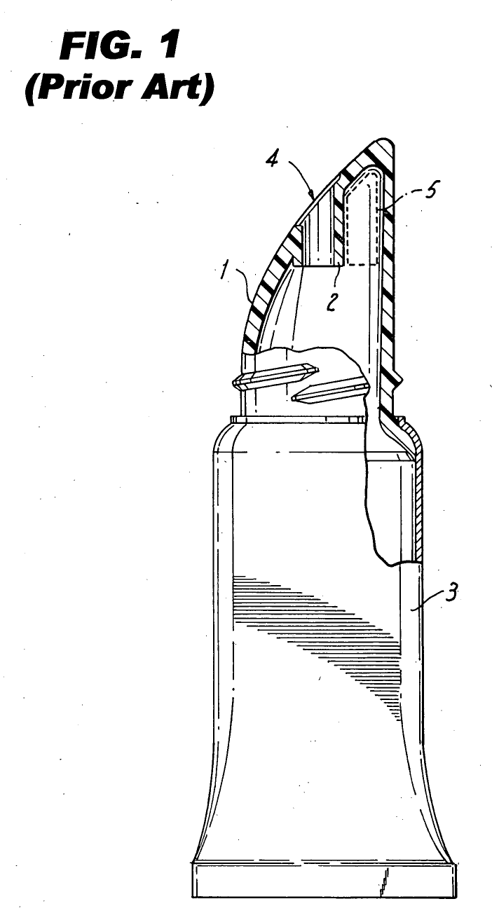

### DETAILED DESCRIPTION OF THE PREFERRED EMBODIMENT

Referring now to FIGS. 2, 3 and 4, a tip applicator 100 in accordance with the present invention is illustrated. Tip applicator 100 includes a tip head 102 having a truncated body 104 forming an interior 106, an applicator end 108 and a receiving end 110, and a concave applicator surface 112 disposed on applicator end 108 and having a discharge opening 114 within. Tip head 102 also includes a Venturi structure 116 wherein one end 116A of Venturi structure 116 opens to the discharge opening 114 and another end 116B opens to receiving end 110 of truncated body 104. Venturi structure 116 in this embodiment is a short tube with a constricted throat or neck 116C. Constriction 116C causes the velocity of a substance 130 being transported therein to increase and to decrease the pressure inside Venturi structure 116. Thus, Venturi structure 116 assists in discharging substance 130 and in the “recapture” of substance 130 back into a pliable tube 118. The nature of the “recapture” of the substance is further described below.

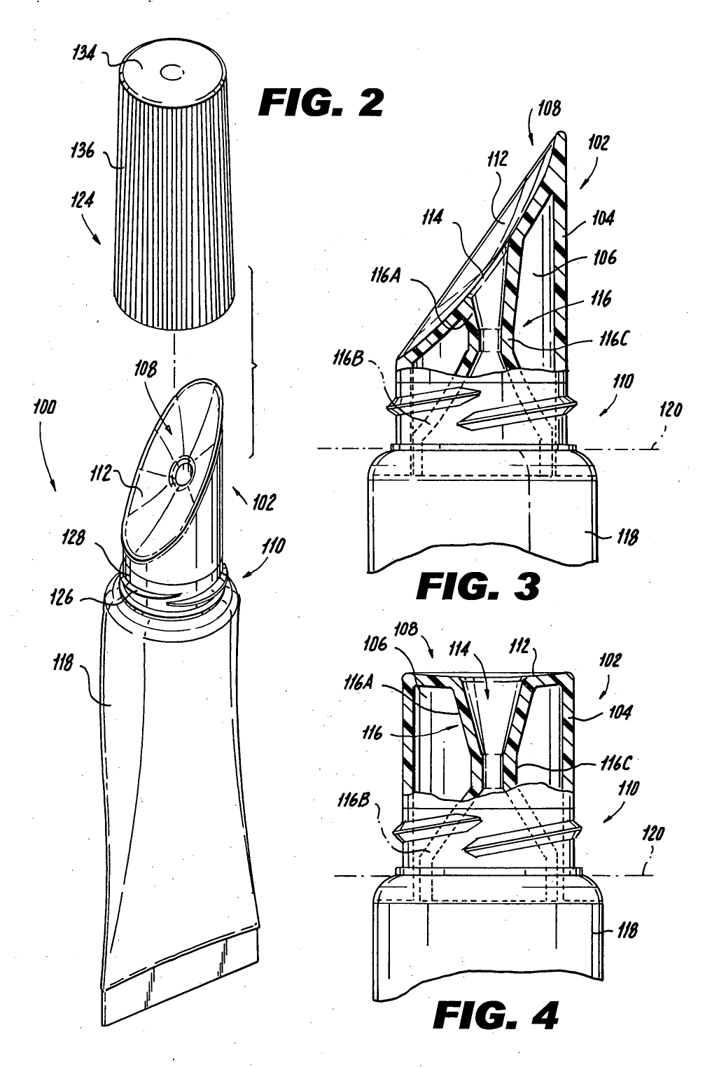

Referring now to FIGS. 3 and 4, concave applicator surface 112 can be at any orientation. Concave applicator surface 112 can be angled with respect to a horizontal axis 120 (FIG. 3) or parallel to horizontal axis 120 (FIG. 4).

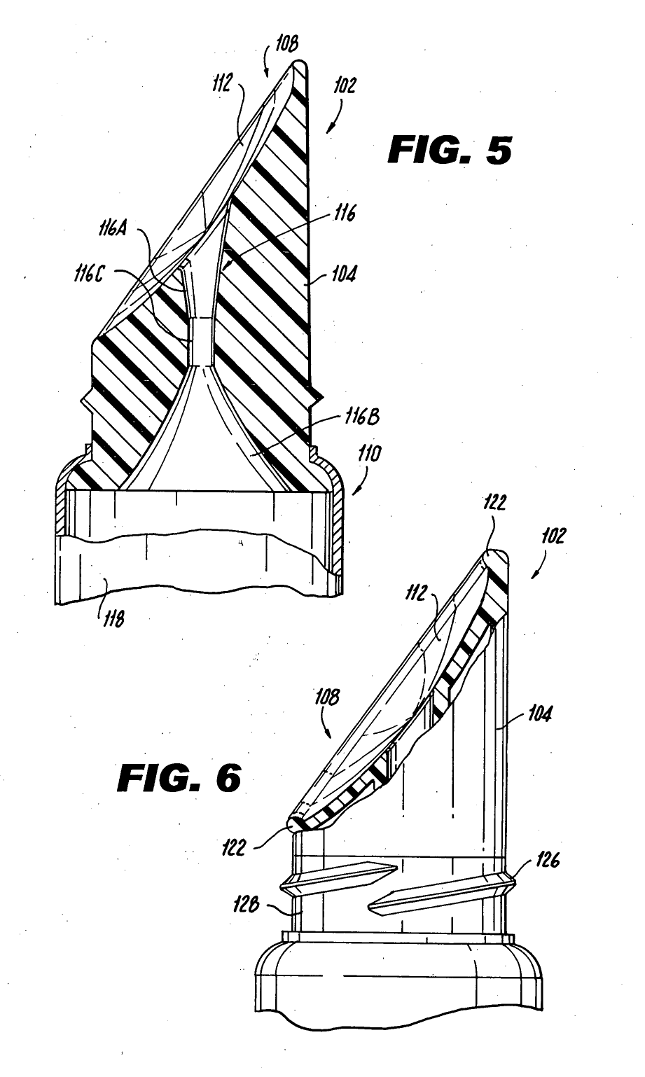

Preferably, truncated body 104 is shaped as a cylinder, as illustrated in FIG. 2, but can be any shape known in the applicator tip art. FIG. 5 illustrates tip applicator 100 in which truncated body 104 and Venturi structure 116 are integrally formed to eliminate entrainment space within tip head 102.

Referring to FIG. 6, tip applicator 100 further includes a lip 122 formed on concave applicator surface 112 adapted to hold excess topical substance. Further, concave applicator surface 112 may have a continuously changing curvilinear shape.

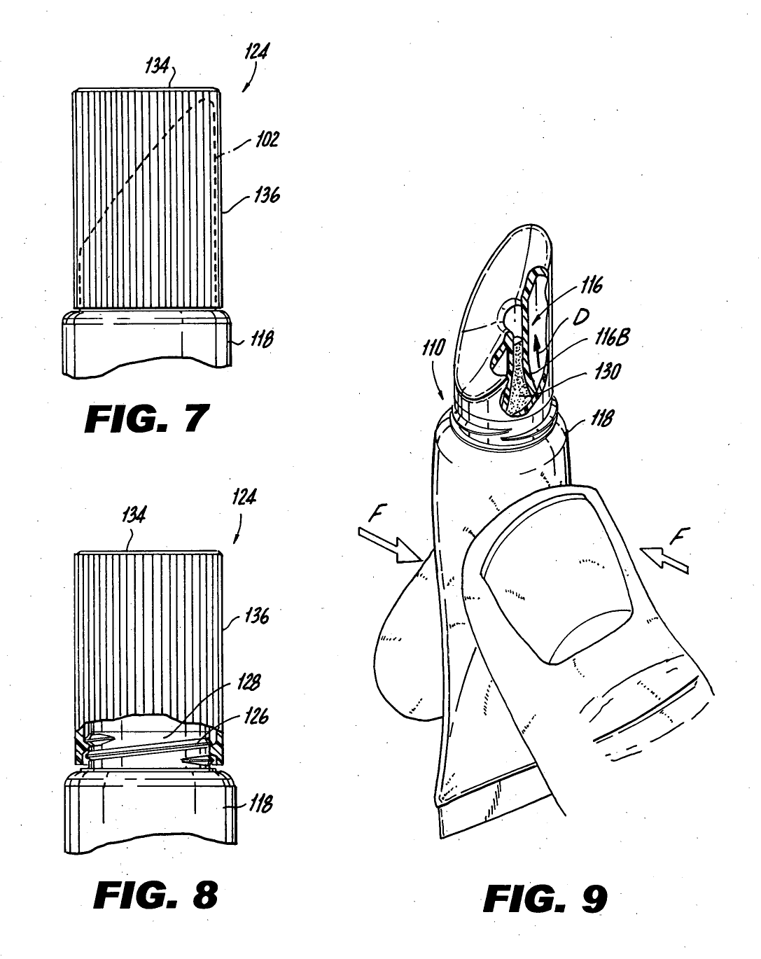

Referring now to FIGS. 2, 6-8, and 12, a cap 124 is engagable to and covering tip head 102. Additionally, FIGS. 2, 6 and 8 illustrate that tip applicator 100 can include a thread 126 disposed on an exterior 128 of truncated body 104 and cap 124 can be threadable engageable with tip head 102.

Referring now to FIGS. 2, 9, and 10, illustrating pliable tube 118 communicating with receiving end 110 of truncated body 104 wherein pliable tube 118 contains topical substance 130. Pliable tube 118 maybe made of any pliable material. Additionally, pliable tube 118 can also be an FDA (Food and Drug Administration) approved vessel for containing pharmaceutical products. A consideration when dispensing a pharmaceutical product is that once the product is dispensed from the tube; the product should either be discharged or returned to the tube for storage. Product that remains inside the tip and not in the tube may spoil or harden and may contaminate the remaining product. The present invention is designed to discharge a majority of the product dispensed from the tube and recover the remainder back into the pliable tube.

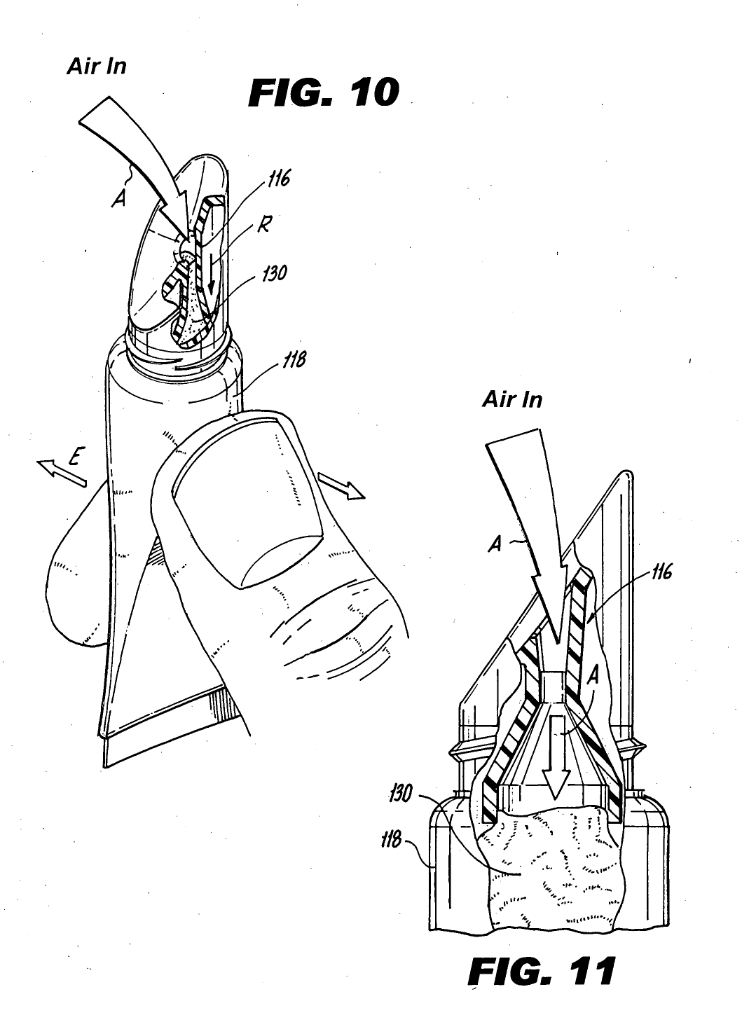

Referring to FIG. 9, compression of pliable tube 118, by a force F, discharges topical substance 130 into end 116B of Venturi structure 116 disposed at receiving end 110 of truncated body 104. Substance 130 then flows through Venturi structure 116 and is discharged through discharge orifice 114 onto concave applicator surface 112 (arrow D). Further, as illustrated in FIGS. 10 and 11, pliable tube 118 can be resiliently expandable after compression (as shown by arrow E) to draw excess substance 130 out of Venturi structure 116 and into pliable tube 118 due to the vacuum formed within pliable tube 118 from the discharge of substance 130. Additionally, Venturi structure 116 assists in forcing substance 130 back into pliable tube 118. While substance 130 is being discharged, the pressure developed in Venturi structure 116 is less than the pressure outside discharge orifice 114. Once force F is released from pliable tube 118, air will rush into Venturi structure 116 to equalize the pressure (arrow A). This inrush of air helps force substance 130 out of Venture structure 116 and back into pliable tube 118.

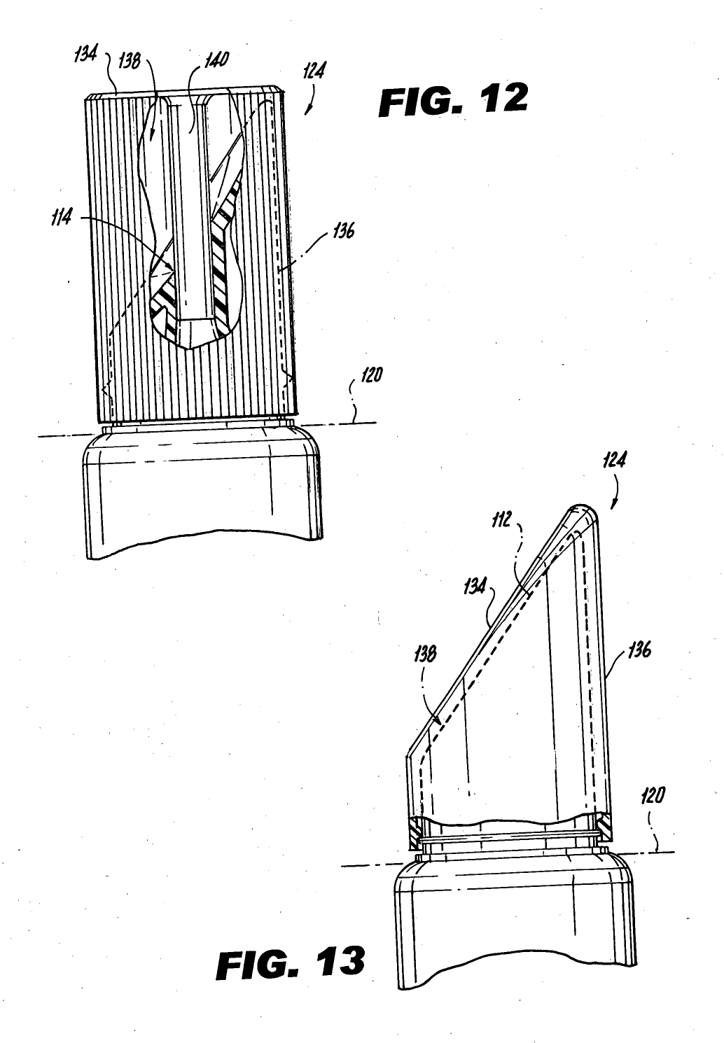

Regarding FIGS. 12 and 13, cap 124 includes a top wall 134 and a side wall 136 vertically depending from top wall 134 and forming an interior 138. FIG. 12 illustrates a plunger 140 disposed on top wall 134, inside interior 136, and aligned with discharge opening 114. Plunger 140 is insertable into discharge opening 114 when cap 124 is engaged with tip head 102. FIG. 12 further illustrates that top wall 134 can be aligned with horizontal axis 120 or FIG. 13 illustrates that top wall 134 can be aligned with concave applicator surface 112.

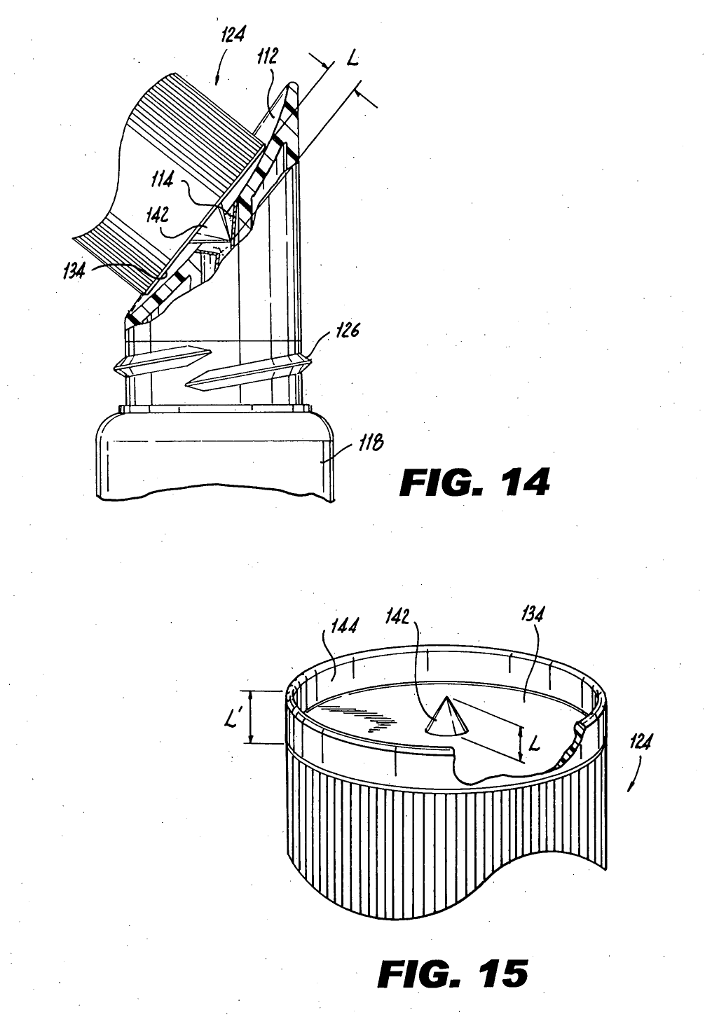

Regarding FIG. 14, cap 124 can include a pin 142 disposed on top wall 134 on the exterior of cap 124, having a length L, and shaped to enter discharge opening 114. FIG. 15 illustrates that cap 124 can further have a shoulder 144 disposed on top wall 134, exterior to cap 124 and having a length L′ longer than length L of pin 142.

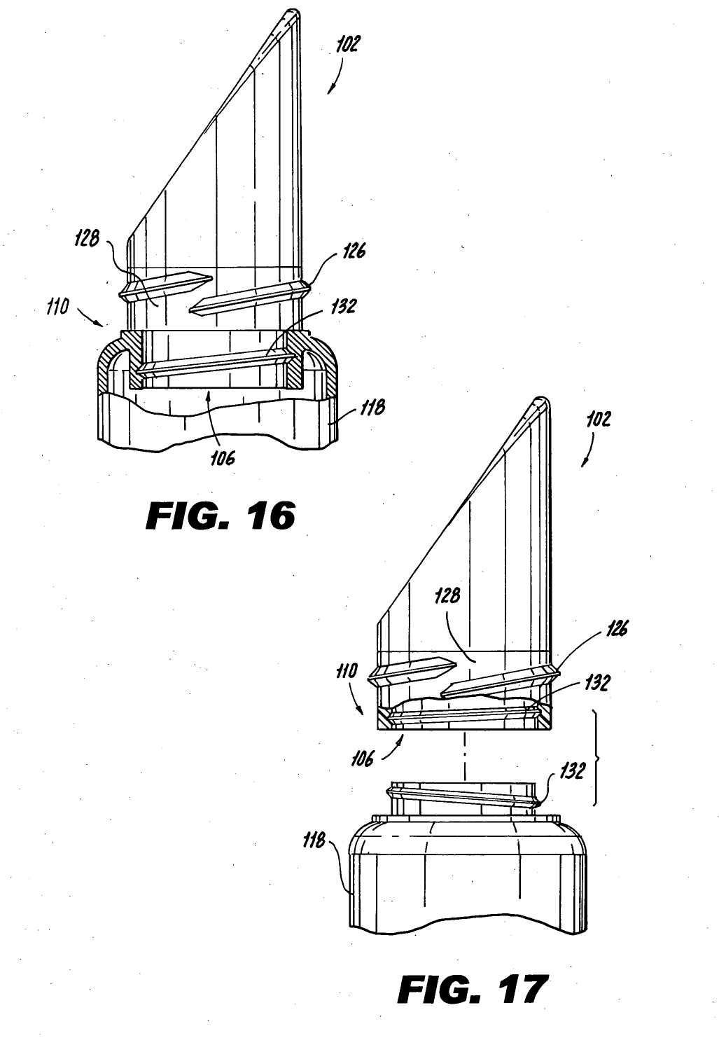

FIGS. 16 and 17 illustrate a thread 132 disposed on interior 106 of truncated body 104 and pliable tube 118 can be threadably engageable with receiving end 110. Further, FIG. 16 illustrates an exterior thread 126 disposed on exterior 128 of truncated body 104, cap 124 is threadably engageable with exterior thread 126, an interior thread 132 disposed on interior 106 of truncated body 104, and pliable tube 118 is threadably engageable with interior thread 132, where exterior thread 126 is threaded one of clockwise and counter-clockwise and interior thread 132 is threaded the same as exterior thread 126. Alternately, as illustrated in FIG. 17, exterior thread 126 can be threaded one of clockwise and counter-clockwise and interior thread 132 is threaded the opposite of exterior thread 126.

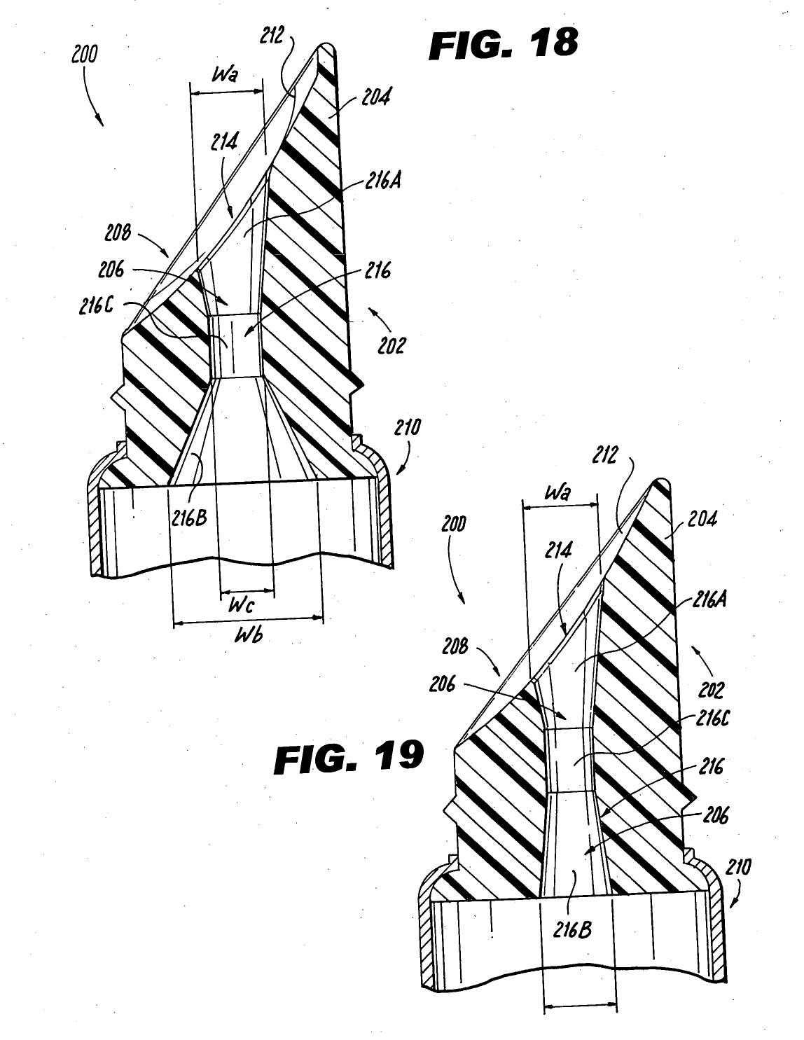

Referring now to FIGS. 18 and 19, another embodiment for a tip applicator 200 is illustrated. Tip applicator 200 includes a tip head 202 including a truncated body 204 forming an interior 206 and an applicator end 208 and an receiving end 210. A concave applicator surface 212 is disposed on applicator end 208 and having a discharge opening 214 within. Tip applicator further includes a discharge tube 216 having a discharge end 216A receiving to discharge opening 214 and having a first width Wa; an opposite end 216B receiving to receiving end 210 and having a second width Wb; and a neck portion 216C disposed between discharge end 216A and opposite end 216B having a third width Wc that is smaller than both first width Wa and second width Wb. FIG. 19 illustrates that first width Wa can equal second width Wb.

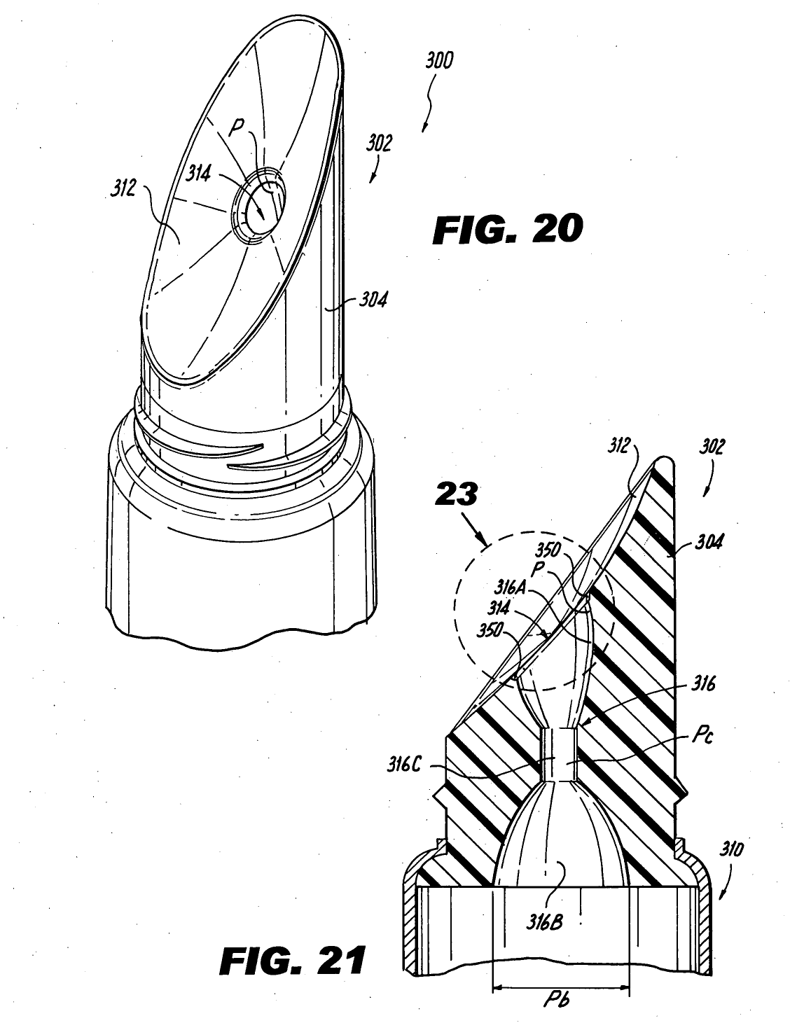

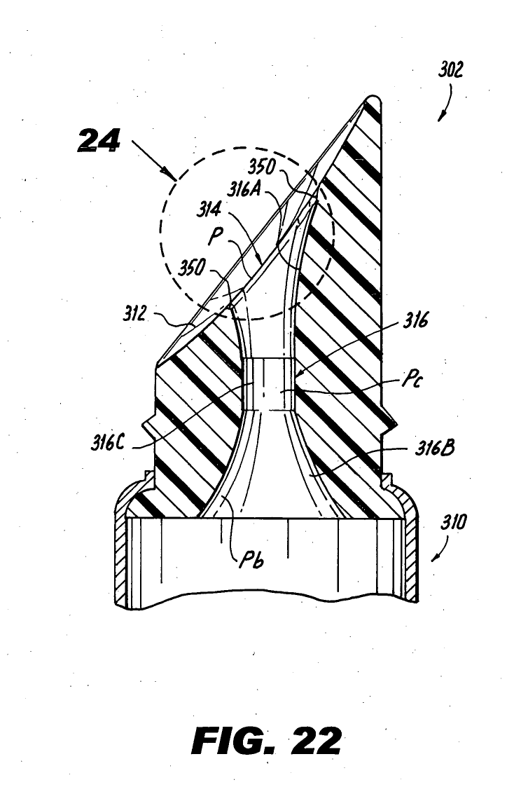

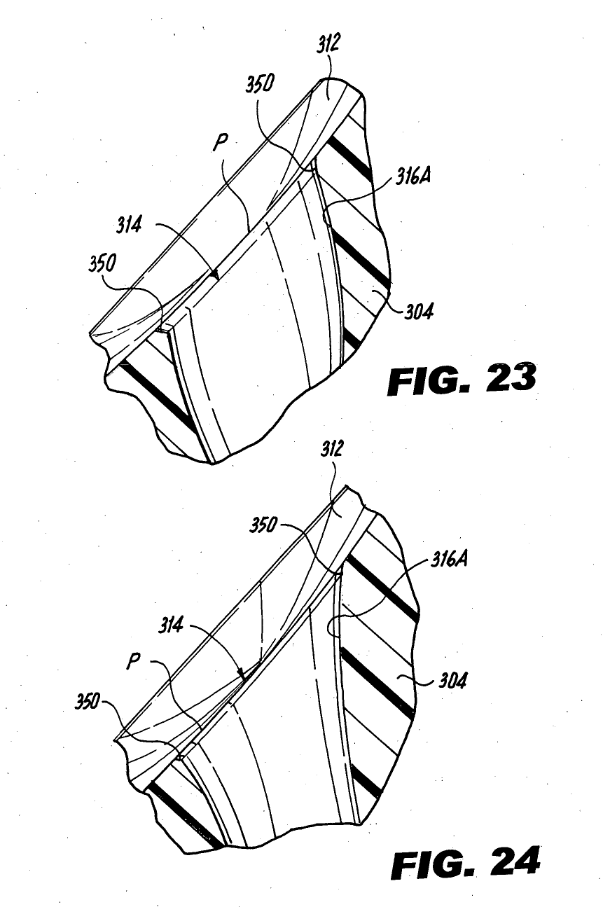

FIGS. 20-24 illustrate another embodiment for tip applicator 300 which includes tip head 302, truncated body 304, and concave applicator surface 312. Referring to FIGS. 20-24, discharge opening 314 has a perimeter P and a point of inflection 350 disposed on concave applicator surface 312 at discharge opening 314. Further, a discharge tube 316 includes a curved wall 316A originating at point of inflection 350, spanning the entire perimeter P of discharge opening 314 and depending into truncated body 304. A neck portion 316C depends from the curved wall 316A and has a perimeter Pc less than perimeter P of discharge opening 314, and a bottom curved wall 316B depends from neck portion 316C and has a perimeter Pb greater than neck portion 316C perimeter Pc and opens to receiving end 310 of truncated body 304. Referring to FIGS. 21 and 23, curved wall 316A and bottom curved wall 316B can be concave and FIGS. 22 and 24 illustrate that curved wall 316A and bottom curved wall 316B can be convex.

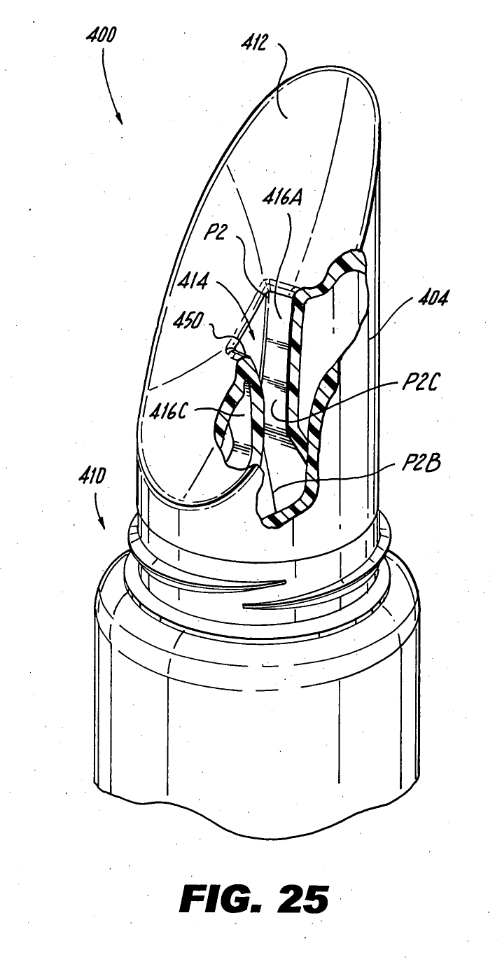

Referring to FIG. 25, another embodiment for tip applicator 400 which includes tip head 402, truncated body 404, and concave applicator surface 412. Discharge opening 414 has a perimeter P2 and a point of intersection 450 disposed on concave applicator surface 412 at discharge opening 414. A discharge tube 416 includes a straight wall 416A originating at point of intersection 450 which spans perimeter P2 of discharge opening 414 and straight wall 416A depends into truncated body 404. Discharge tube 416 further includes a neck portion 416C depending from straight wall 416A and has a perimeter P2C less than perimeter P2 of discharge opening 414 and a bottom straight wall 416B that depends from neck portion 416C and has a perimeter P2B greater than neck portion perimeter P2C and opens to a receiving end 410 of truncated cylinder 404.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, and maybe merely conceptual in nature. It is the intention, therefore, to be limited only as indicated by the scope of the claims appended hereto.

1. A tip applicator for a topical substance comprising:
a tip head comprising:
a truncated body forming an interior and having an applicator end and a receiving end;
a concave applicator surface disposed on the applicator end and having a discharge opening within; and
a Venturi structure wherein one end of the Venturi structure opens to the discharge opening and another end of the Venturi structure opens to the receiving end of the truncated body.

2. The tip applicator of claim 1, wherein the concave applicator surface is angled with respect to a horizontal axis.

3. The tip applicator of claim 1, wherein the concave applicator surface is parallel to a horizontal axis.

4. The tip applicator of claim 1, wherein the truncated body is a cylinder.

5. The tip applicator of claim 1, wherein the truncated body and the Venturi structure are integrally formed to eliminate entrainment space within the tip head.

6. The tip applicator of claim 1, further comprising a pad reservoir formed on the concave applicator surface adapted to hold excess topical substance.

7. The tip applicator of claim 1, further comprising a cap engagable and covering the tip head.

8. The tip applicator of claim 7, further comprising a thread disposed on an exterior of the truncated body and the cap being threadable engageable with the tip head.

9. The tip applicator of claim 1, further comprising:
a pliable tube communicating with the receiving end of the truncated body wherein the pliable tube contains the topical substance and compression of the pliable tube discharges the topical substance into the end of the Venturi structure disposed at the receiving end of the truncated body.

10. The tip applicator of claim 9, further comprising a thread disposed on the interior of the truncated body and the pliable tube being threadably engageable with the receiving end.

11. The tip applicator of claim 9 wherein the pliable tube is expandable after compression to draw excess topical substance out of the Venturi structure and into the pliable tube.

12. The tip applicator of claim 7, wherein the cap comprises:
a top wall; and
a side wall vertically depending from the top wall and forming an interior.

13. The tip applicator of claim 12, wherein the cap further comprises:
a plunger disposed on the top wall, interior to the cap, and aligned with the discharge opening, wherein the plunger is insertable into the discharge opening when the cap is engaged with the tip head.

14. The tip applicator of claim 12, wherein the top wall of the cap is aligned with a horizontal axis.

15. The tip applicator of claim 12, wherein the top wall of the cap is aligned with the concave applicator surface.

16. The tip applicator of claim 12, wherein the cap further comprises:
a pin disposed on the top wall, exterior to the cap, having a length, and shaped to enter the discharge opening.

17. The tip applicator of claim 16, wherein the cap further comprises:
a shoulder disposed on the top wall, exterior to the cap and having a length longer than the length of the pin.

18. The tip applicator of claim 1, wherein said concave applicator surface comprises a continuously changing curvilinear shape.

19. The tip applicator of claim 1, further comprising:
an exterior thread disposed on an exterior of the truncated body;
a cap being threadable engageable with the exterior thread;
an interior thread disposed on the interior of the truncated body; and
a pliable tube being threadably engageable with the interior thread, wherein the exterior thread is threaded one of clockwise and counter-clockwise and the interior thread is threaded the same as the exterior thread.

20. The tip applicator of claim 1, further comprising:
an exterior thread disposed on an exterior of the truncated body;
a cap being threadable engageable with the exterior thread;
an interior thread disposed on the interior of the truncated body; and
a pliable tube being threadably engageable with the interior thread, wherein the exterior thread is threaded one of clockwise and counter-clockwise and the interior thread is threaded the opposite of the exterior thread.

21. A tip applicator for a topical substance comprising:
a tip head comprising:
a truncated body forming an interior and having an applicator end and an receiving end;
a concave applicator surface disposed on the applicator end and having a discharge opening within;
a discharge tube comprising:
a discharge end receiving to the discharge opening and having a first width;
an opposite end receiving to the receiving end of the truncated body and having a second width; and
a neck portion disposed between the discharge end and the opposite end having a third width, wherein the third width is smaller than both the first width and the second width.

22. The tip applicator of claim 21, wherein the first width equals the second width.

23. A tip applicator for a topical substance comprising:
a tip head comprising:
a truncated body forming an interior and having an applicator end and a receiving end;
a concave applicator surface disposed on the applicator end and having a discharge opening within and the discharge opening having a perimeter;
a point of inflection disposed on the concave applicator surface at the discharge opening; and
a discharge tube comprising:
a curved wall originating at the point of inflection, spanning the entire perimeter of the discharge opening and depending into the truncated body;
a neck portion depending from the curved wall having a perimeter less than the perimeter of the discharge opening; and
a bottom curved wall depending from the neck portion having a perimeter greater than the neck portion and opening to the receiving end of the truncated body.

24. The tip applicator of claim 23, wherein the curved wall and the bottom curved wall are concave.

25. The tip applicator of claim 23, wherein the curved wall and the bottom curved wall are convex.

26. A tip applicator for a topical substance comprising:
a tip head comprising:
a truncated body forming an interior and having an applicator end and a receiving end;
a concave applicator surface disposed on the applicator end and having a discharge opening within and the discharge opening having a perimeter;
a point of intersection disposed on the concave applicator surface at the discharge opening; and
a discharge tube comprising:
a straight wall originating at the point of intersection, spanning the entire perimeter of the discharge opening and depending into the truncated body;
a neck portion depending from the straight wall having a perimeter less than the perimeter of the discharge opening; and
a bottom straight wall depending from the neck portion having a perimeter greater than the neck portion and opening to the receiving end of the truncated body.
